(19) United States
(12) Patent Application Publication
(10) Pub. No.: US 2025/0381647 A1
(43) Pub. Date: Dec. 18, 2025

(54) SUPPORT ASSEMBLY FOR A FRAME STRUCTURE AND A METHOD OF SUPPORTING THE FRAME STRUCTURE

(71) Applicant: The Boeing Company, Arlington, VA (US)

(72) Inventors: Chester James Hill, IV, Grafton, IL (US); Brent Beach, St. Louis, MO (US)

(73) Assignee: The Boeing Company, Arlington, VA (US)

(21) Appl. No.: 18/746,863

(22) Filed: Jun. 18, 2024

(51) Int. Cl. B25B 5/00

(52) U.S. Cl. CPC B25B 5/006

(57) ABSTRACT

A support assembly and a method for a frame structure having a first frame section and a second frame section includes a support frame having arms extending outwardly to present a support grid. Connector apparatuses are arranged on the support grid, and each includes a lock coupled to a pin to selectively fix the pin in a stationary position relative to the support frame. Each of the connector apparatuses include a clamp configured to selectively attach together the frame structure and the support frame. The clamp of each of the connector apparatuses cooperates with the respective pin to attach the first frame section to the support frame when the respective clamp is in the locked position which fixes the first frame section on the support grid of the arms in an arrangement that provides repeatable nominal attachment and detachment of the second frame section relative to the first frame section.

### BACKGROUND

Some manufacturing processes require parts of a frame structure to be separated at certain stages of the process. For example, it may be desirable to separate a skin panel from a substructure in order to perform other processes to the skin panel but not to the substructure. The frame structure may be suspended on a bracket, and the skin panel is separated from the substructure while being suspended on the bracket. However, the substructure may shift or sag on the bracket once the skin panel is removed. The skin panel and the substructure will need to be realigned relative to each other if the substructure shifts or sags.

### SUMMARY

Therefore, it is desirable to develop a support assembly for a frame structure and a method of supporting the frame structure that improves manufacturing processes, and other benefits are discussed herein.

The present disclosure provides a support assembly for a frame structure having a first frame section and a second frame section. The support assembly includes a support frame. The support frame includes a plurality of arms extending outwardly to present a support grid. The support assembly includes a plurality of connector apparatuses each arranged on the support grid. Each of the connector apparatuses includes a pin movable axially along a longitudinal axis and a lock coupled to the pin. The lock is configured to release the pin in a disengaged position to allow movement of the pin relative to the support frame. The lock is configured to engage the pin in an engaged position to fix the pin in a stationary position relative to the support frame. Each of the connector apparatuses include a clamp configured to move from a locked position in which the clamp attaches together the frame structure and the support frame and an unlocked position in which the clamp releases the frame structure from the support frame. The clamp of each of the connector apparatuses cooperates with the respective pin to attach the first frame section to the support frame when the respective clamp is in the locked position which fixes the first frame section on the support grid of the arms in an arrangement that provides repeatable nominal attachment and detachment of the second frame section relative to the first frame section.

The present disclosure also provides a method of supporting a frame structure including a first frame section and a second frame section. The frame structure is positioned relative to a support frame. The support frame includes a plurality of arms extending outwardly to present a support grid, and a plurality of connector apparatuses are each arranged on the support grid. A pin of each of the connector apparatuses is moved axially along a longitudinal axis to position the pin relative to the frame structure. A lock is activated to engage the pin in an engaged position to fix the pin in a stationary position relative to the support frame or to release the pin in a disengaged position to allow movement of the pin relative to the support frame. A clamp of each of the connector apparatuses is operated to move to a locked position in which the clamp attaches together the frame structure and the support frame or to move to an unlocked position in which the clamp releases the frame structure from the support frame. Operation of the clamp to the locked position fixes the first frame section on the support grid of the arms in an arrangement that provides repeatable nominal attachment and detachment of the second frame section relative to the first frame section.

The detailed description and the drawings or FIGS. are supportive and descriptive of the disclosure, but the claim scope of the disclosure is defined solely by the claims. While some of the best modes and other configurations for carrying out the claims have been described in detail, various alternative designs and configurations exist for practicing the disclosure defined in the appended claims.

### BRIEF DESCRIPTION OF THE DRAWINGS

FIG. 1 is a schematic perspective front side view of the support assembly having a frame structure hung on a support frame.

FIG. 2 is a schematic enlarged view taken from line 2 of FIG. 1.

FIG. 3 is a schematic perspective back side view of the support assembly of FIG. 1.

FIG. 4 is a schematic fragmented perspective view of the support frame having a plurality of different connector apparatuses supporting the frame structure.

FIG. 5 is a schematic fragmented perspective view of the support frame illustrating optional telescoping beam portions.

FIG. 6 is a schematic fragmented perspective view of two example connector apparatuses.

FIG. 7 is another schematic fragmented perspective view of the connector apparatuses of FIG. 6.

FIG. 8 is a schematic fragmented perspective view of another two example connector apparatuses.

FIG. 9 is a schematic fragmented perspective view of one of the example connector apparatuses of FIG. 8.

FIG. 10 is a schematic fragmented perspective view of the other one of the example connector apparatuses of FIG. 8.

FIG. 11 is a schematic perspective view of the connector apparatus of FIG. 10 removed from the support frame.

FIG. 12 is a schematic fragmented perspective view of the connector apparatus of FIG. 11.

FIG. 13 is a schematic cross-sectional view of the connector apparatus of FIG. 11.

FIG. 14 is a schematic fragmented perspective view of one of the example connector apparatuses of FIG. 6, with a bracket removed.

FIG. 15 is a schematic fragmented perspective view of the connector apparatus of FIG. 14, with the bracket shown.

FIG. 16 is a schematic fragmented cross-sectional view of the connector apparatus of FIG. 15.

FIG. 17 is a schematic illustration of a first frame section hung from the support frame with a second frame section removed from the first frame section.

The present disclosure may be extended to modifications and alternative forms, with representative configurations shown by way of example in the drawings and described in detail below. Inventive aspects of the disclosure are not limited to the disclosed configurations. Rather, the present disclosure is intended to cover modifications, equivalents, combinations, and alternatives falling within the scope of the disclosure as defined by the appended claims.

### DETAILED DESCRIPTION

Those having ordinary skill in the art will recognize that all directional references (e.g., above, below, upward, up, downward, down, top, bottom, left, right, vertical, horizontal, etc.) are used descriptively for the FIGS. to aid the reader's understanding, and do not represent limitations (for example, to the position, orientation, or use, etc.) on the scope of the disclosure, as defined by the appended claims. Moreover, terms such as “first,” “second,” “third,” and so on, may be used to describe separate components. Such terminology may include the words specifically mentioned above, derivatives thereof, and words of similar import. Furthermore, the term “substantially” can refer to a slight imprecision or slight variance of a condition, quantity, value, or dimension, etc., some of which are within manufacturing variance or tolerance ranges.

As used herein, an element or step recited in the singular and preceded by the word “a” or “an” should be understood as not necessarily excluding the plural of the elements or steps. Further, any reference to “one configuration” is not intended to be interpreted as excluding the existence of additional configurations that also incorporate the recited features. Moreover, unless explicitly stated to the contrary, configurations “comprising” or “having” an element or a plurality of elements having a particular property may include additional elements not having that property. The phrase “at least one of” as used herein should be construed to include the non-exclusive logical “or”, i.e., A and/or B and so on depending on the number of components.

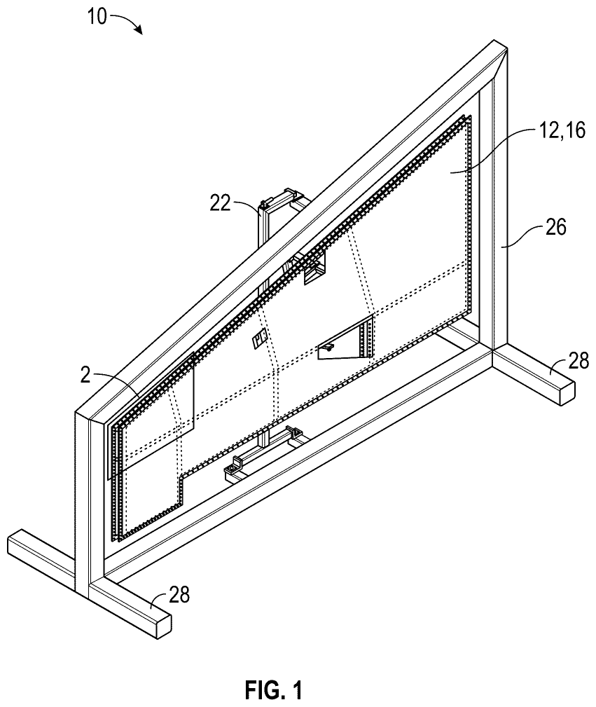

Referring to the figures, wherein like numerals indicate like or corresponding parts throughout the several views, a support assembly 10 for a frame structure 12 having a first frame section 14 and a second frame section 16 is generally shown in FIGS. 1-3. The frame structure 12 is a determinate assembly in which the first frame section 14 and the second frame sections 16 each define a plurality of holes 18 of determinate size. That is, the frame structure 12 is a full-scale development article, i.e., the determinate assembly, that has full size, i.e. determinate size, holes 18 that no additional drilling of the holes 18 occurs in a later process.

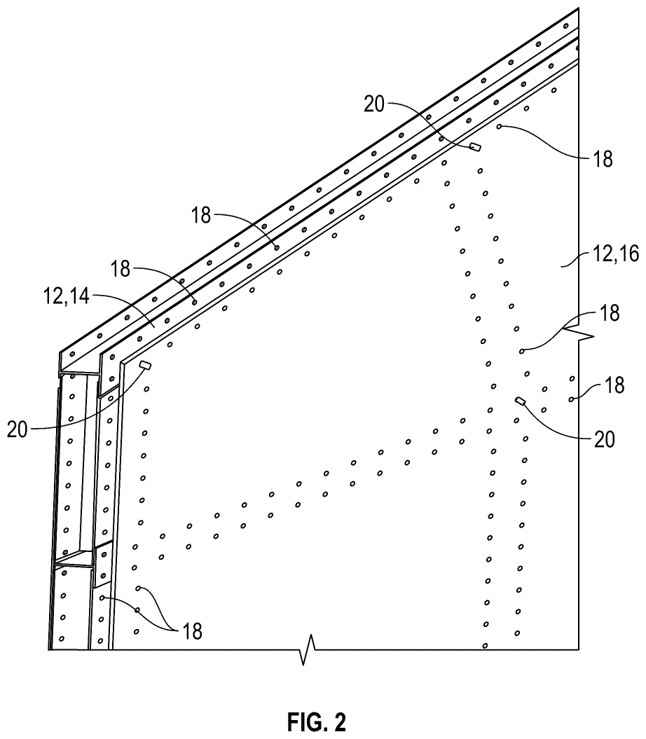

The respective holes 18 of the first frame section 14 and the respective holes 18 of the second frame section 16 aligns with each other, and a plurality of locating fasteners 20 (see FIG. 2, in which the locating fasteners 20 are shown in dash-dot-dot-dash lines to represent non-limiting example pinning locations) are disposed through a predetermined number of the aligned holes 18 of the first frame section 14 and the second frame section 16 to present an assembled state. FIGS. 1-4 illustrate the first frame section 14 and the second frame section 16 attached to each other in the assembled state. The locating fasteners 20 secure the first frame section 14 and the second frame section 16 nominally relative to each other.

The frame structure 12 may be any suitable configuration used in various applications, and non-limiting examples of the applications may include flight vehicles, such as aircraft, drones, payloads, space shuttles, satellites, etc.; movable platforms, such as locomotives, automobiles, off-road vehicles, watercrafts, trailers, farm equipment, etc.; non-movable platforms such as equipment, buildings, farm equipment, or any other applications where the support assembly 10 described herein may be utilized for the frame structure 12. For example, non-limiting examples of the structures for an aircraft may include one or more panels, skins, frames, brackets, spars, chords, engine cowl, stringers, bulkheads, doors, or any other structural members that may use the support assembly 10 described herein.

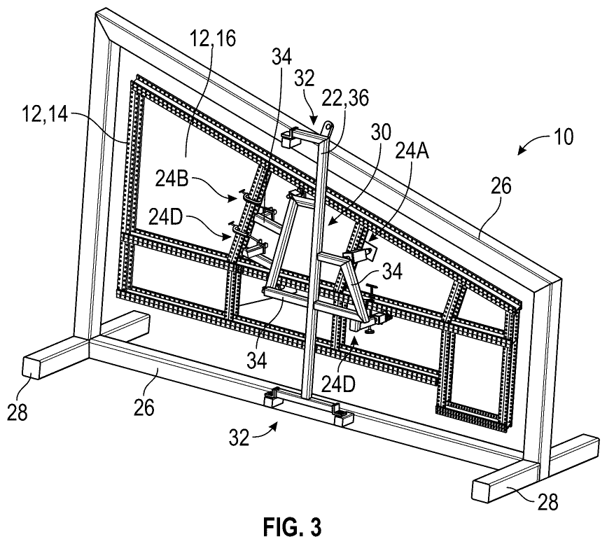

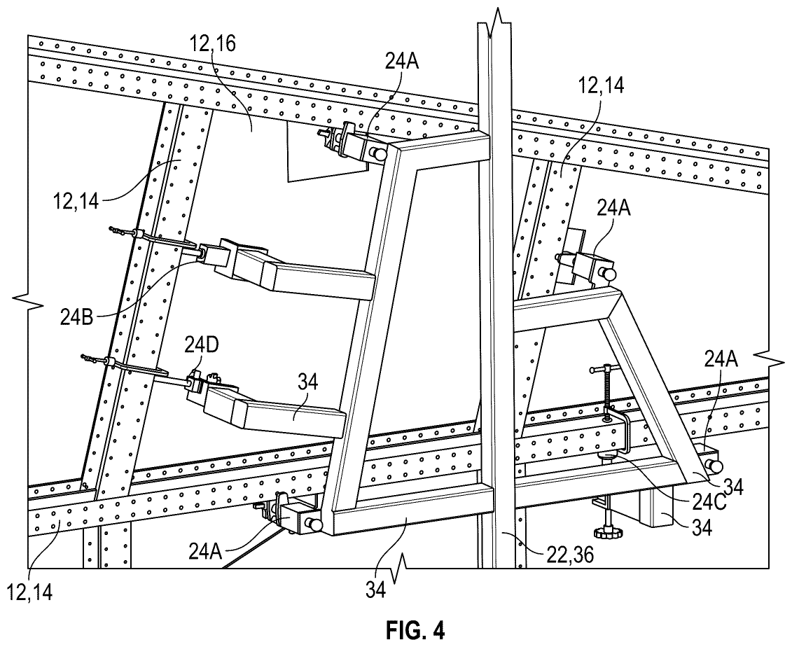

Referring to FIGS. 3 and 4, the support assembly 10 includes a support frame 22 and a plurality of connector apparatuses 24A, 24B, 24C, 24D coupled thereto. The frame structure 12 is attached to the support frame 22 via the connector apparatuses 24A, 24B, 24C, 24D in the nominal orientation.

Referring to FIGS. 1 and 3, the support frame 22 may be attached to a secondary support structure or outer cage 26 such that the secondary support structure 26 supports the support frame 22. The secondary support structure 26 may include a plurality of extremities 28 to stabilize the secondary support structure 26 and the support frame 22. In certain configurations, the support frame 22 may be generally disposed along a central portion 30 of the secondary support structure 26, i.e., disposed away from distal ends 32 of the secondary support structure 26.

Turning to FIGS. 3 and 4, the support frame 22 includes a plurality of arms 34 extending outwardly to present a support grid, and each of the connector apparatuses 24A, 24B, 24C, 24D are arranged on the support grid. Therefore, one or more of the arms 34 may have one or more of the connector apparatuses 24A, 24B, 24C, 24D attached thereto to present the support grid. The arms 34 may be in any suitable configuration, and non-limiting examples are shown in the figures.

Generally, the support frame 22 may include a central beam 36 and each of the arms 34 extend outwardly from the central beam 36. The central beam 36 may be fixed or attached to the secondary support structure 26 to fix the support frame 22 to the secondary support structure 26.

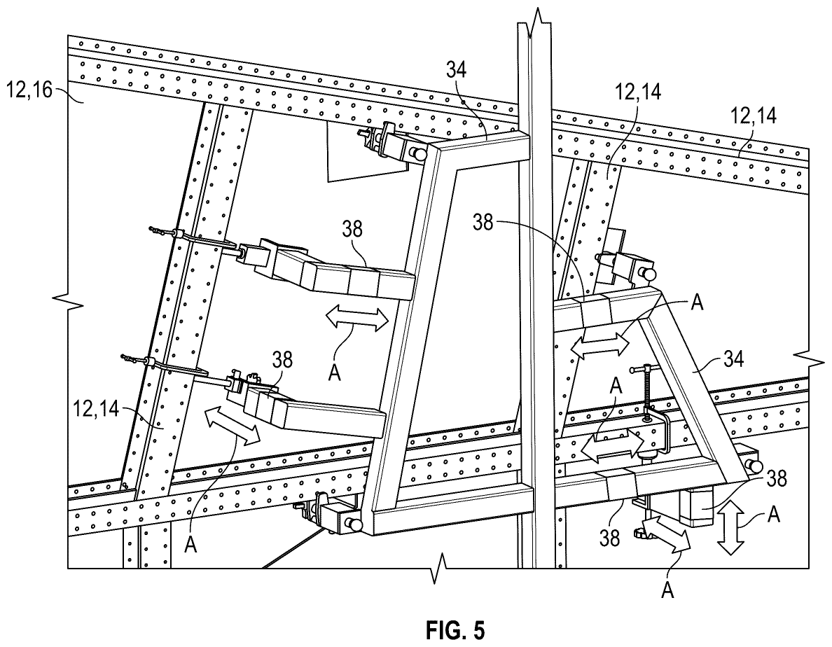

In certain configurations, the support frame 22 is adjustable in order to accommodate different types of the frame structures 12 and/or to accommodate different shapes and/or sizes of the frame structures 12. Optionally, one or more of the arms 34 may be adjusted relative to the central beam 36 to change the support grid. For illustrative purposes, FIG. 5 illustrates some possible directions of adjustability of any of the arms 34 (see arrows A). Generally, the arms 34 may be adjusted up or down, left or right, angularly or any other suitable direction of adjustability. By adjusting any of the arms 34, the location and/or position of the corresponding one or more of the connector apparatuses 24A, 24B, 24C, 24D also changes. Therefore, one or more of the arms 34 may include a telescoping beam portion 38 to change a position of one or more of the connector apparatuses 24A, 24B, 24C, 24D relative to the central beam 36. Any of the figures herein may optionally incorporate the telescoping beam portion 38 even if it is not shown in all of the figures.

As best shown in FIGS. 4 and 5, the connector apparatuses 24A, 24B, 24C, 24D may be various configurations, and these figures are non-limiting examples. It is to be appreciated that any combination of different connector apparatuses 24A, 24B, 24C, 24D may be used with the corresponding support frame 22 or all of the same connector apparatuses 24A, 24B, 24C, 24D may be used with the corresponding support frame 22. Next, common features of each of the connector apparatuses 24A, 24B, 24C, 24D of the different configurations are discussed.

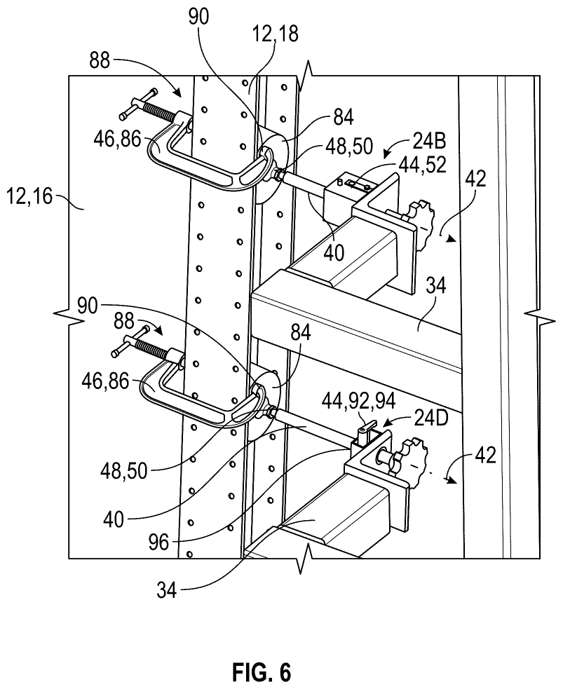

Referring to FIGS. 6-8, each of the connector apparatuses 24A, 24B, 24C, 24D includes a pin 40 movable axially along a longitudinal axis 42 and a lock 44 coupled to the pin 40. The lock 44 is configured to release the pin 40 in a disengaged position to allow movement of the pin 40 relative to the support frame 22 and the lock 44 is configured to engage the pin 40 in an engaged position to fix the pin 40 in a stationary position relative to the support frame 22. Generally, to attach the frame structure 12 to the support frame 22, as the frame structure 12 is held relative to the support frame 22, the pin 40 is movable axially to cause part of the respective connector apparatuses 24A, 24B, 24C, 24D to engage the frame structure 12, and more specifically, cause part of the respective connector apparatuses 24A, 24B, 24C, 24D to engage the first frame section 14, and then the lock 44 moves to the engaged position to fix the pin 40 into position relative to the first frame section 14 which creates a non-load inducing type of support, which thus, prevents imparting forces or deformations into the first frame section 14.

Continuing with FIGS. 6-8, each of the connector apparatuses 24A, 24B, 24C, 24D includes a clamp 46 configured to move from a locked position in which the clamp 46 attaches together the frame structure 12 and the support frame 22 and an unlocked position in which the clamp 46 releases the frame structure 12 from the support frame 22. More specifically, the clamp 46 of each of the connector apparatuses 24A, 24B, 24C, 24D cooperates with the respective pin 40 to attach the first frame section 14 to the support frame 22 when the respective clamp 46 is in the locked position which fixes the first frame section 14 on the support grid of the arms 34 in an arrangement that provides repeatable nominal attachment and detachment of the second frame section 16 relative to the first frame section 14.

Once each of the connector apparatuses 24A, 24B, 24C, 24D are in the locked position, the frame structure 12 is secured to the support frame 22 at the desired support location to prevent sagging and/or shifting (as discussed in the background section above) of the first frame section 14 when the second frame section 16 is removed from the first frame section 14. That is, the first frame section 14 and the second frame section 16 remain nominal relative to each other when hung from the support frame 22.

Referring to FIGS. 6-8, each of the connector apparatuses 24A, 24B, 24C, 24D may include at least one support foot 48 coupled to the respective pin 40 at a pivot point 50. The support foot 48 is pivotable relative to the respective pin 40 via the pivot point 50. Therefore, the support foot 48 may be disposed on a ball joint to allow independent movement of the support foot 48 relative to the respective pin 40. By having the support foot 48 movable or adjustable relative to the pivot point 50, the support foot 48 may be adjusted to provide the desired contact with another structure such as the first frame section 14 or other desired structure.

The connector apparatuses 24A, 24B, 24C, 24D may be various configurations, and four non-limiting examples are illustrated in the figures. Even though the figures illustrate different connector apparatuses 24A, 24B, 24C, 24D being used with one support frame 22, it is to be appreciated that the connector apparatuses 24A, 24B, 24C, 24D may all be the same configuration coupled to the support frame 22 or two or more different configurations may be coupled to the support frame 22 in any desired combination.

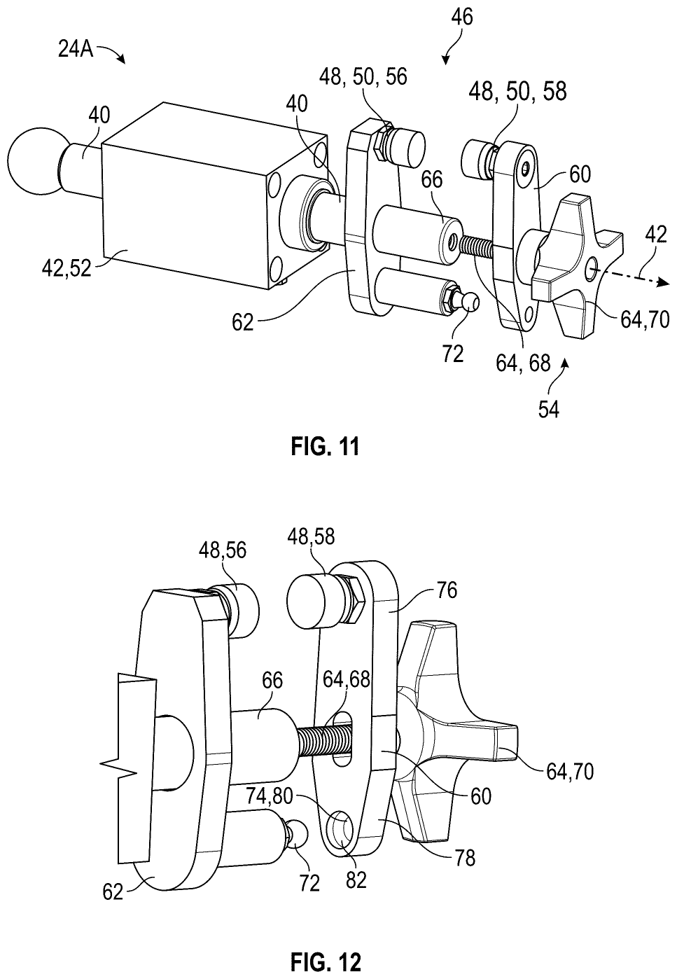

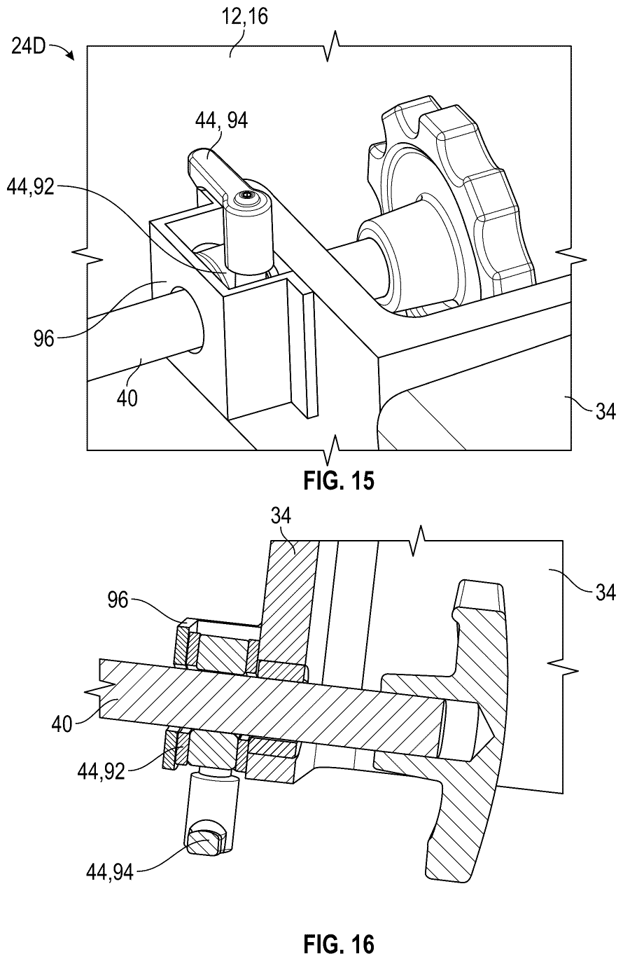

Turning to the connector apparatuses 24A, 24B, 24C, 24D of FIGS. 6-16, non-limiting examples of the lock 44 and the clamp 46 are illustrated, and it is to be appreciated that the lock 44 and the clamp 46 may be in any suitable configuration to attach or detach the frame structure 12 from the support frame 22. Each configuration of the lock 44 and the clamp 46 will be discussed next.

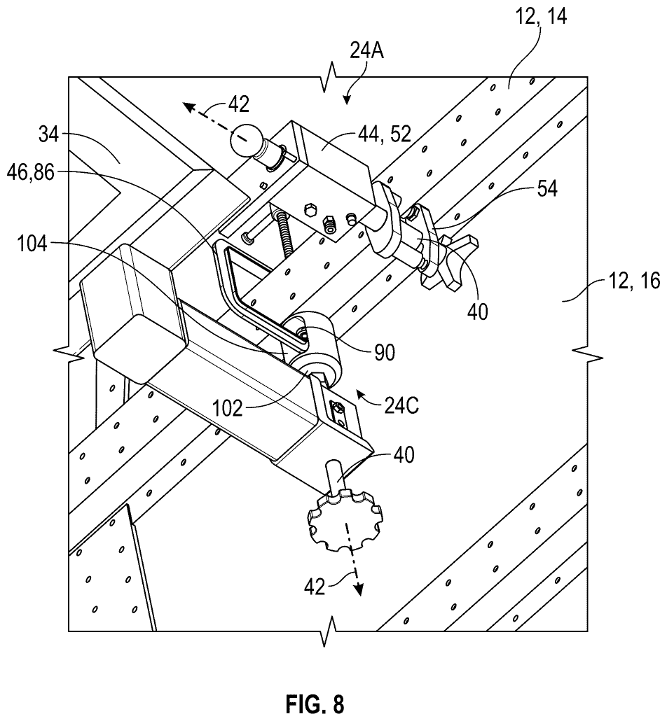

Referring to FIG. 6, two different connector apparatuses 24B, 24D are illustrated and referring to FIG. 8, another two different connector apparatuses 24A, 24C are illustrated. Some of these configurations have commonality, and therefore, will be discussed together.

Referring to FIGS. 6 and 8, the lock 44 of at least one of the connector apparatuses 24A, 24B, 24C may be further defined as a collet 52. Therefore, the collet 52 is attached to the respective one of the arms 34 in the arrangement of the support grid. The collet 52 allows the pin 40 to move axially to the desired position and then the collet 52 is activated to the engaged position to lock the pin 40 in the desired position. The collet 52 may surround the respective pin 40 and engage the pin 40 to lock the pin 40 in the engaged position. That is, the collet 52 may apply pressure, or a holding force, to the pin 40 to lock the pin 40 in the engaged position. The collet 52 may be activated or operated mechanically, pneumatically, hydraulically, electrically, or any other suitable way.

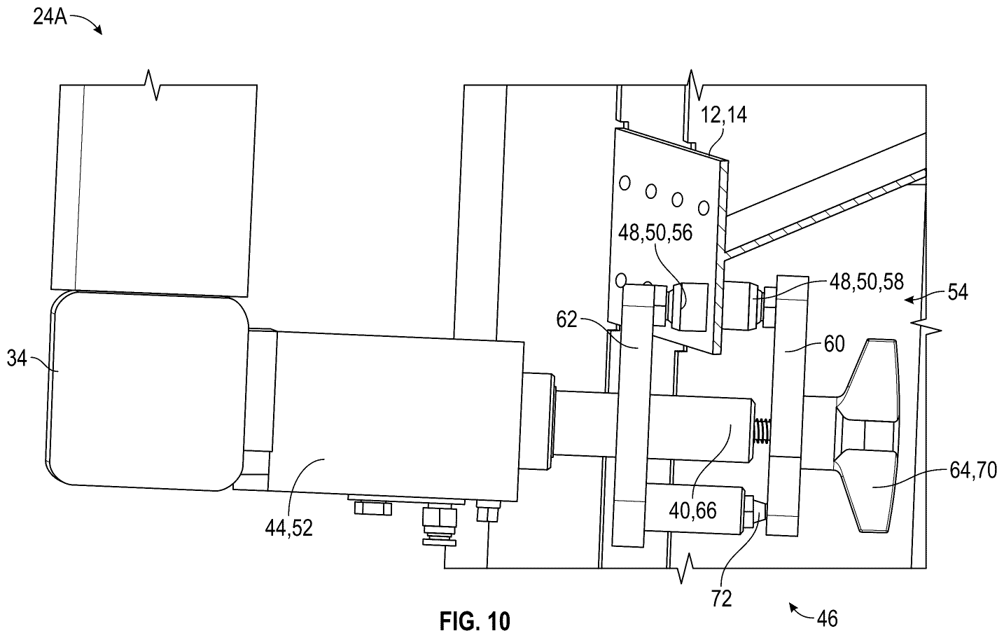

Turning to FIGS. 10-13, the clamp 46 of at least one of the connector apparatuses 24A may include a sub-assembly 54 separable from the respective pin 40 to position the frame structure 12 relative to the support frame 22. That is, the sub-assembly 54 is removed until the support foot 48 is moved into position relative to the first frame section 14 via the pin 40, and then, the sub-assembly 54 is attached to the pin 40 to sandwich the first frame section 14 between the support foot 48 and the sub-assembly 54. As such, the sub-assembly 54 is couplable to the respective pin 40 to attach the frame structure 12 to the support frame 22.

Continuing with the configuration of FIGS. 10-13, the at least one support foot 48 may be further defined as a plurality of support feet 48. The support feet 48 may be referred to as leveling feet. A first one 56 of the support feet 48 is coupled to the respective pin 40 and engages a first part of the first frame section 14, and a second one 58 of the support feet 48 is coupled to the respective sub-assembly 54 and engages a second part of the first frame section 14 to sandwich part of the frame structure 12 (more specifically sandwich part of the first frame section 14) between a pair of the first and second ones 56, 58 of the support feet 48. The sub-assembly 54 of the clamp 46 may include a platform 60 and the second one 58 of the support feet 48 may be coupled to the platform 60 at a pivot point 50. The second one 58 of the support feet 48 is pivotable relative to the platform 60 via the pivot point 50. Each of the support feet 48 may be disposed on a ball joint to allow independent movement of the respective support feet 48. Therefore, by having the support feet 48 movable or adjustable relative to the respective pivot point 50, the support feet 48 may be adjusted to provide the desired contact with the sides of the first frame section 14.

Again, continuing with FIGS. 10-13, the clamp 46 of at least one of the connector apparatuses 24A may include a flange 62 fixed to and extending outwardly from the respective pin 40. The flange 62 has the pivot point 50, and the first one 56 of the support feet 48 is pivotably coupled to the flange 62 at the pivot point 50. Generally, the flange 62 extends radially away from the longitudinal axis 42 such that the first one 56 of the support feet 48 is spaced from the pin 40. In other words, the flange 62 may extend radially away from the longitudinal axis 42 in two different directions such that the pin 40 is disposed between two portions of the flange 62.

Continuing with FIGS. 10-13, the sub-assembly 54 may include a fastener component 64 disposed through the platform 60. The fastener component 64 may be fed into the pin 40 to attach the sub-assembly 54 to the pin 40 such that the first one 56 and the second one 58 of the support feet 48 sandwich or clamp 46 the frame structure 12 (more specifically sandwich the first frame section 14) therebetween in the locked position. Generally, the platform 60 may extend radially away from the fastener component 64 in two different directions such that the fastener component 64 is disposed between two portions of the platform 60. The fastener component 64 may be rotatable about the longitudinal axis 42 to thread into a distal end 66 of the respective pin 40. In certain configurations, the fastener component 64 may include a screw 68 and a knob 70 coupled to each other. The screw 68 is exposed out of one side of the platform 60 and selectively screws 68 into the pin 40. The knob 70 is exposed from an opposing side of the platform 60 such that movement of the knob 70 correspondingly moves the screw 68 into or out of the pin 40. It is to be appreciated that the fastener component 64 may be any suitable configuration to selectively attach to the pin 40, and the screw 68 is one non-limiting example.

Continuing with FIGS. 10-13, the clamp 46 of at least one of the connector apparatuses 24A may include a post 72 extending from the flange 62 or the platform 60. The other one of the flange 62 or the platform 60 engages the post 72 at a pivot 74 such that the flange 62 or the platform 60 is pivotable relative to the pivot 74 to move the second one 58 of the support feet 48 toward the first one 56 of the support feet 48 when moving the clamp 46 to the locked position. Therefore, in certain configurations, the post 72 is attached to one part of the flange 62 and the first one 56 of the support feet 48 is attached to another part of the flange 62, and turning to the platform 60, the pivot 74 is disposed on one part of the platform 60 and the second one 58 of the support feet 48 is attached to another part of the platform 60. More specifically, the platform 60 may include a first end 76 having the second one 58 of the support feet 48 pivotably coupled thereto and a second end 78 having the pivot 74.

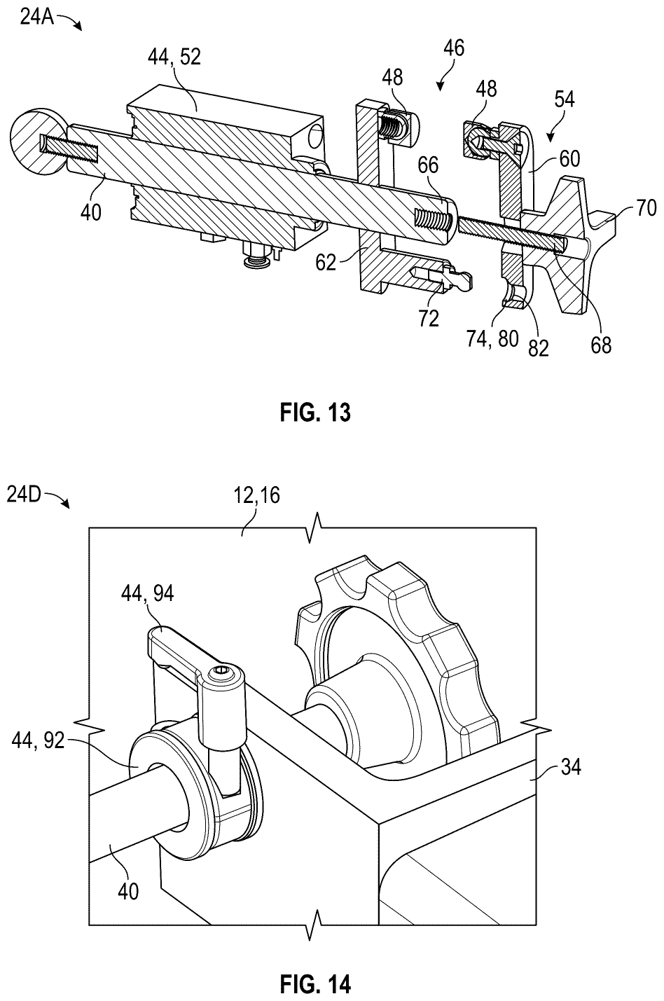

Continuing with FIGS. 10-13, in certain configurations, the post 72 extends from the flange 62 and the pivot 74 is disposed in the platform 60. Generally, the pivot 74 is spaced radially away from the longitudinal axis 42. Also, in certain configurations, the pivot 74 may be defined as a recess 80 and the post 72 is seated in the recess 80 when the sub-assembly 54 is attached to the pin 40. The platform 60 may define the recess 80 and the platform 60 may include a sloped surface 82 (see FIGS. 12 and 13) disposed inside of the recess 80, and engagement of the post 72 with the sloped surface 82 prevents translational movement of the sub-assembly 54 but allows pivoting of the sub-assembly 54 about the post 72 to clamp the first frame section 14 via the clamp 46 without binding the clamp 46. In certain configurations, the post 72 may be referred to as a ball stud. The post 72, i.e., the ball stud, cooperate with the recess 80 such that the sub-assembly 54 may pivot 74 thereon which forces the second one 58 of the support feet 48 attached to the platform 60 toward the first one 56 of the support feet 48 attached to the flange 62 to clamp the first frame section 14 therebetween when moving to the locked position. As such, the features attached to the pin 40 and the sub-assembly 54 form the clamp 46 of this configuration.

Continuing with FIGS. 10-13, the pivot point 50 of the first one 56 of the support feet 48 and the second one 58 of the support feet 48 are spaced radially away from the longitudinal axis 42 to prevent the pin 40 from interfering with the placement of the frame structure 12. For this configuration, the pin 40 may also be rotatable about the longitudinal axis 42 to correspondingly rotate the flange 62 which changes a position of the first one 56 of the support feet 48, which assists in aligning the first one 56 of the support feet 48 in the desired position relative to the first frame section 14 to attach to the first frame section 14, or the flange 62 may be rotated to move the first one 56 of the support feet 48 out of the way to remove the frame structure 12 from the support frame 22.

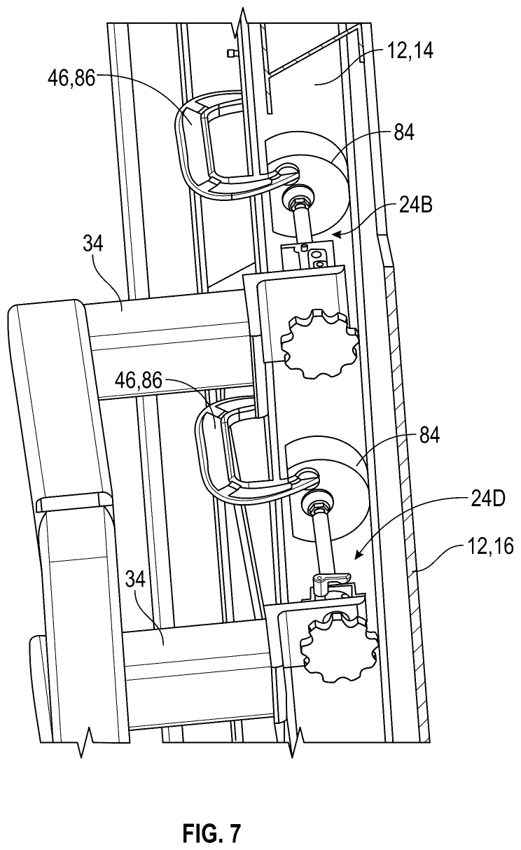

Turning to FIGS. 6 and 7, two different connector apparatuses 24B, 24D are illustrated. In these configurations, at least one of the connector apparatuses 24B, 24D may include a bearing block 84 sandwiched between the first frame section 14 and the support foot 48 of the respective pin 40 when the clamp 46 is in the locked position. The pivot point 50 is disposed at the distal end 66 of the respective pin 40 such that the support foot 48 is pivotable relative to the longitudinal axis 42, and the support foot 48 may engage the bearing block 84 when the frame structure 12 is being hung from the support frame 22. The bearing block 84 may act as a step to reduce the amount of axial movement the pin 40 moves to the desired position to fix the pin 40 in the engaged position, and to reduce the amount of movement for the clamp 46 to move to the locked position. Also, the bearing block 84 may act as a step so that the clamp 46 may engage the bearing block 84 without interference from the first frame section 14.

Continuing with FIGS. 6 and 7, in these configurations, the clamp 46 may be further defined as a C-clamp 86. The C-clamp 86 may include a first foot 88 engaging a first part of the first frame section 14, and a second foot 90 engaging the bearing block 84 at a second part of the first frame section 14 to sandwich part of the frame structure 12 between the first foot 88 and the second foot 90.

Continuing with FIGS. 6 and 7, the lock 44 of one of the connector apparatuses 24B is illustrated as the collet 52, which has been described above, and the lock 44 of another one of the connector apparatuses 24D is illustrated as a collar 92. Therefore, the lock 44 of at least one of the connector apparatuses 24D may be further defined as the collar 92 surrounding the respective pin 40. The collar 92 may include a lever 94 to operate the lock 44 to the disengaged position and the engaged position. The lever 94 may be operated in any suitable direction, such as rotated or translated to selectively lock the pin 40 into the desired position. At least one of the connector apparatuses 24D may include a bracket 96 attached to the respective one of the arms 34 to couple the collar 92 to the respective one of the arms 34.

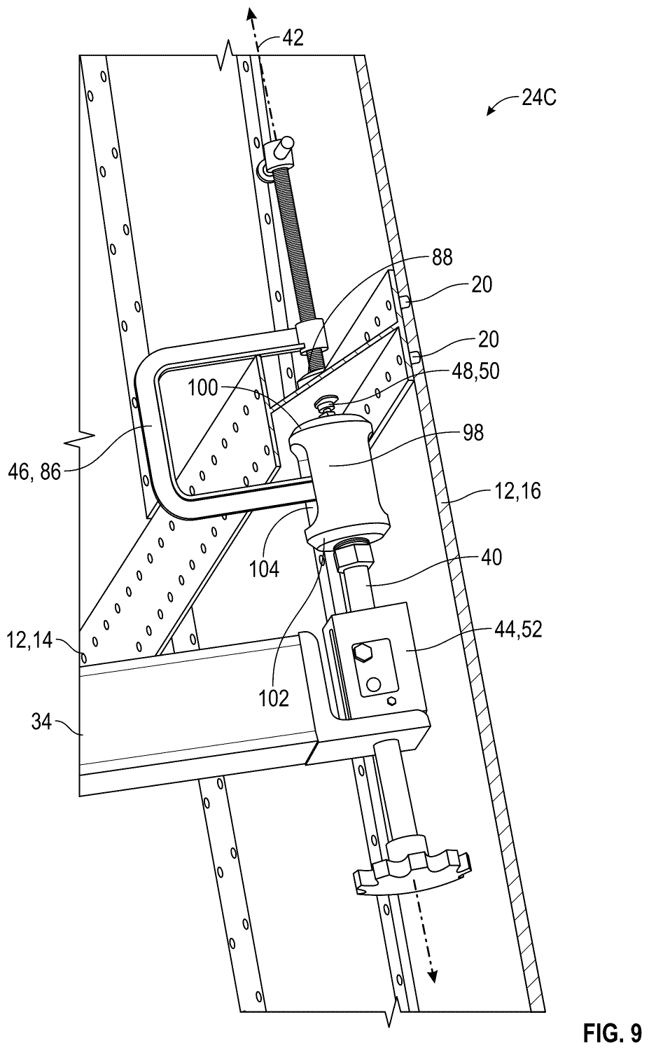

Turning to FIG. 9, the lock 44 of one of the connector apparatuses 24C is illustrated as the collet 52, which has been described above, and in this configuration, at least one of the connector apparatuses 24C may include a cylinder 98 attached to the pin 40. The cylinder 98 may include a first end 100 and a second end 102 opposing each other along the longitudinal axis 42. The support foot 48 is coupled to the respective pin 40 via the cylinder 98. More specifically, the support foot 48 is coupled to the first end 100 of the cylinder 98 along the longitudinal axis 42 such that the support foot 48 is pivotable relative to the longitudinal axis 42. The respective pin 40 is coupled to the second end 102 of the cylinder 98. Therefore, movement (axial movement and/or rotational movement) of the pin 40 correspondingly moves the cylinder 98.

Referring to FIGS. 8 and 9, the cylinder 98 may define a cutout 104. Generally, the cutout 104 is disposed between the first end 76 and the second end 78. In this configuration, the clamp 46 may be further defined as a C-clamp 86. Part of the C-clamp 86 is disposed in the cutout 104 when the C-clamp 86 is in the locked position. More specifically, the C-clamp 86 may include a first foot 88 engaging a first part of the first frame section 14, and a second foot 90 disposed inside of the cutout 104 to engage the cylinder 98 which positions the support foot 48 of the cylinder 98 between the first foot 88 and the second foot 90 such that the support foot 48 of the cylinder 98 engages a second part of the first frame section 14 to sandwich part of the frame structure 12 between the first foot 88 and the second foot 90 when the clamp 46 is in the locked position. As such, the respective pin 40, the first foot 88 of the C-clamp 86, and the second foot 90 of the C-clamp 86 aligns with the support foot 48 along the longitudinal axis 42 when the clamp 46 is in the locked position.

The present disclosure also provides a method of supporting the frame structure 12 including the first frame section 14 and the second frame section 16. As mentioned above, the frame structure 12 is the determinate assembly in which the first frame section 14 and the second frame sections 16 each define the plurality of holes 18 of the determinate size. The method assists in maintaining the first frame section 14 and the second frame section 16 nominally relative to each other, which eliminates having to realign the holes 18. As such, the method prevents the frame structure 12 from sagging and/or shifting when the second frame section 16 is temporarily removed from the first frame section 14, which allows for quick remating of the second frame section 16 to the first frame section 14.

To attach the frame structure 12 to the support frame 22, the frame structure 12 is positioned relative to the support frame 22. As discussed above, the support frame 22 includes the plurality of arms 34 extending outwardly to present the support grid. The support grid may be arranged to correspond to the configuration of the frame structure 12.

The plurality of connector apparatuses 24A, 24B, 24C, 24D are each arranged on the support grid and used to attach the frame structure 12 to the support frame 22. As mentioned above, in certain configurations, all of the same connector apparatuses 24A, 24B, 24C, 24D may be used on the support frame 22, or alternatively, one or more different connector apparatuses 24A, 24B, 24C, 24D may be used on the support frame 22. Once the frame structure 12 is positioned relative to the support frame 22, each of the connector apparatuses 24A, 24B, 24C, 24D are operated one at a time or more than one may be operated at the same time or operated in any suitable order or sequence. It is to be appreciated that the connector apparatuses 24A, 24B, 24C, 24D may be operated manually or automatically via a robot or a controller.

The pin 40 of each of the connector apparatuses 24A, 24B, 24C, 24D are adjusted relative to the frame structure 12. More specifically, the pin 40 of each of the connector apparatuses 24A, 24B, 24C, 24D is moved axially along the longitudinal axis 42 to position the pin 40 relative to the frame structure 12. Optionally, the pin 40 of one or more of the connector apparatuses 24A, 24B, 24C, 24D may be rotated into the desired position.

Once the pin 40 of each of the connector apparatuses 24A, 24B, 24C, 24D are in the desired position relative to the frame structure 12, the lock 44 may be operated to move to the engaged position. More specifically, the lock 44 is activated to engage the pin 40 in the engaged position to fix the pin 40 in the stationary position relative to the support frame 22. If the pin 40 needs adjusting relative to the frame structure 12 or if it is desirable to remove the frame structure 12 from the support frame 22, the lock 44 is activated to release the pin 40 to the disengaged position to allow movement of the pin 40 relative to the support frame 22.

Once the pin 40 of the corresponding connector apparatuses 24A, 24B, 24C, 24D is locked in place, the corresponding clamp 46 may be operated. The clamp 46 of each of the connector apparatuses 24A, 24B, 24C, 24D is operated to move to the locked position in which the clamp 46 attaches together the frame structure 12 and the support frame 22. If the clamp 46 needs adjusting relative to the frame structure 12 or if it is desirable to remove the frame structure 12 from the support frame 22, the clamp 46 is operated to move to the unlocked position in which the clamp 46 releases the frame structure 12 from the support frame 22.

The clamp 46 is operated to the locked position which fixes the first frame section 14 on the support grid of the arms 34 in an arrangement that provides repeatable nominal attachment and detachment of the second frame section 16 relative to the first frame section 14.

Once each of the connector apparatuses 24A, 24B, 24C, 24D are in the locked position, the frame structure 12 is secured to the support frame 22 at the desired support locations to prevent sagging and/or shifting of the first frame section 14 when the second frame section 16 is removed from the first frame section 14. That is, the first frame section 14 and the second frame section 16 remain nominal when hung from the support frame 22.

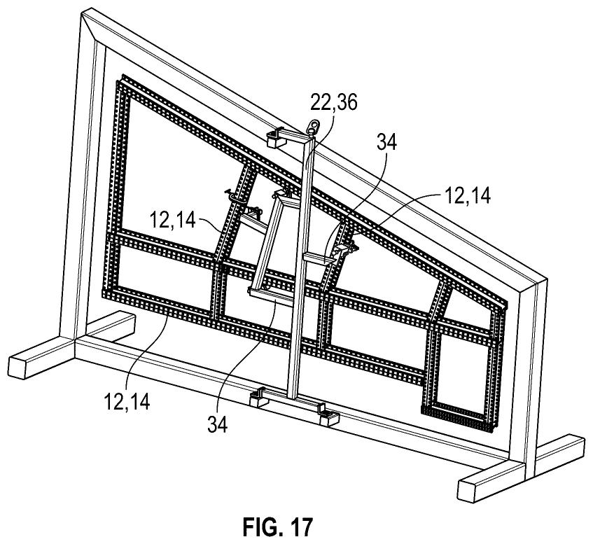

Next, the second frame section 16 may be removed from the first frame section 14 while the first frame section 14 remains fixed to the support grid. To do so, the locating fasteners 20 may be removed from at least the first frame section 14 and/or the second frame section 16. More specifically, the locating fasteners 20 are removed from the first frame section 14 and/or the second frame section 16 to separate the second frame section 16 from the first frame section 14 to present a disassembled state. FIG. 17 illustrates the first frame section 14 after the second frame section 16 has been removed, and thus the disassembled state. For illustrative purposes, FIG. 17 also illustrates a different number of connector apparatuses 24A, 24B, 24C, 24D as compared to FIG. 3, and as well as a different arrangement of the arms 34 and the support grid as compared to FIG. 3.

As illustrated in FIG. 17, the first frame section 14 remains attached to the support frame 22 when the second frame section 16 is removed. The locations of the support grid as well as the configurations of the connector apparatuses 24A, 24B, 24C, 24D assist in preventing sag and/or shifting of the first frame section 14 when the second frame section 16 is removed therefrom.

Once the second frame section 16 is removed from the first frame section 14, a task may be performed to the second frame section 16. Performing the task occurs after removing the second frame section 16 from the first frame section 14 and while the first frame section 14 remains fixed to the support grid. The task performed to the second frame section 16 may be a manufacturing process required for the second frame section 16 and not the first frame section 14. Therefore, the second frame section 16 may be moved to another processing station to perform the manufacturing process.

Once the task to the second frame section 16 has been completed, the second frame section 16 is reattached to the first frame section 14 while the first frame section 14 remains fixed to the support grid via the connector apparatuses 24A, 24B, 24C, 24D. Generally, reattaching the second frame section 16 occurs after performing the task to the second frame section 16.

In certain configurations, reattaching the second frame section 16 to the first frame section 14 may further include aligning the holes 18 of the second frame section 16 to the holes 18 of the first frame section 14 and pinning the second frame section 16 to the first frame section 14 once the corresponding holes 18 are aligned. The locating fasteners 20 may be reinserted into the desired holes 18 of the first frame section 14 and the second frame section 16 to reattach the second frame section 16 to the first frame section 14 which returns the first frame section 14 and the second frame section 16 back to the nominal orientation in the assembled state. This reattachment of the second frame section 16 occurs while the first frame section 14 remains attached to the support frame 22. After the second frame section 16 is reattached to the first frame section 14, the reassembled frame structure 12 may be removed from the support frame 22 by unlocking each of the connector apparatuses 24A, 24B, 24C, 24D.

In certain configurations, it is desirable to change the configuration of the support grid to accommodate another configuration of the frame structure 12. To do so, at least one of the arms 34 may be repositioned to change the arrangement of the support grid to accommodate a different configuration of the frame structure 12. In certain configurations, repositioning the at least one of the arms 34 may further include telescoping the telescoping beam portion 38 to move at least one of the arms 34 to change the position of the respective connector apparatuses 24A, 24B, 24C, 24D.

It is to be appreciated that the order or sequence of performing the method as discussed herein is for illustrative purposes and other orders or sequences are within the scope of the present teachings. It is to also be appreciated that the method may include other features not discussed immediately above.

While the best modes and other configurations for carrying out the disclosure have been described in detail, those familiar with the art to which this disclosure relates will recognize various alternative designs and configurations for practicing the disclosure within the scope of the appended claims. Furthermore, the configurations shown in the drawings or the characteristics of various configurations mentioned in the present description are not necessarily to be understood as configurations independent of each other. Rather, it is possible that each of the characteristics described in one of the examples of a configuration can be combined with one or a plurality of other desired characteristics from other configurations, resulting in other configurations not described in words or by reference to the drawings. Accordingly, such other configurations fall within the framework of the scope of the appended claims.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The illustrations of the configurations described herein are intended to provide a general understanding of the structure of the various configurations. The illustrations are not intended to serve as a complete description of all of the elements and features of apparatuses and systems that utilize the structures or methods described herein. Many other configurations may be apparent to those of skill in the art upon reviewing the disclosure. Other configurations may be utilized and derived from the disclosure, such that structural and logical substitutions and changes may be made without departing from the scope of the disclosure. Accordingly, the disclosure and the figures are to be regarded as illustrative rather than restrictive.

The following Clauses provide some example configurations of the support assembly 10 and the method as disclosed herein.

Clause 1: A support assembly for a frame structure having a first frame section and a second frame section, the support assembly comprising: a support frame including a plurality of arms extending outwardly to present a support grid; a plurality of connector apparatuses each arranged on the support grid, wherein each of the connector apparatuses include a pin movable axially along a longitudinal axis and a lock coupled to the pin, wherein the lock is configured to release the pin in a disengaged position to allow movement of the pin relative to the support frame and the lock is configured to engage the pin in an engaged position to fix the pin in a stationary position relative to the support frame; and wherein each of the connector apparatuses include a clamp configured to move from a locked position in which the clamp attaches together the frame structure and the support frame and an unlocked position in which the clamp releases the frame structure from the support frame, wherein the clamp of each of the connector apparatuses cooperates with the respective pin to attach the first frame section to the support frame when the respective clamp is in the locked position which fixes the first frame section on the support grid of the arms in an arrangement that provides repeatable nominal attachment and detachment of the second frame section relative to the first frame section.

Clause 2: The support assembly as set forth in clause 1 wherein each of the connector apparatuses include at least one support foot coupled to the respective pin at a pivot point, wherein the support foot is pivotable relative to the respective pin via the pivot point.

Clause 3: The support assembly as set forth in any one of the preceding clauses wherein the lock of at least one of the connector apparatuses is further defined as a collet, and the collet is attached to the respective one of the arms in the arrangement of the support grid.

Clause 4: The support assembly as set forth in any one of the preceding clauses wherein the clamp of at least one of the connector apparatuses include a sub-assembly separable from the respective pin to position the frame structure relative to the support frame, and the sub-assembly is couplable to the respective pin to attach the frame structure to the support frame.

Clause 5: The support assembly as set forth in any one of the preceding clauses wherein each of the connector apparatuses include at least one support foot coupled to the respective pin at a pivot point, wherein the support foot is pivotable relative to the respective pin via the pivot point.

Clause 6: The support assembly as set forth in any one of the preceding clauses wherein the at least one support foot is further defined as a plurality of support feet, wherein a first one of the support feet is coupled to the respective pin and engages a first part of the first frame section, and a second one of the support feet is coupled to the respective sub-assembly and engages a second part of the first frame section to sandwich part of the frame structure between a pair of the first and second ones of the support feet.

Clause 7: The support assembly as set forth in any one of the preceding clauses wherein the clamp of at least one of the connector apparatuses includes a flange fixed to and extending outwardly from the respective pin, wherein the flange has the pivot point, and wherein the first one of the support feet is pivotably coupled to the flange at the pivot point.

Clause 8: The support assembly as set forth in any one of the preceding clauses wherein the sub-assembly of the clamp includes a platform and the second one of the support feet is coupled to the platform at a pivot point, wherein the second one of the support feet is pivotable relative to the platform via the pivot point.

Clause 9: The support assembly as set forth in any one of the preceding clauses wherein the clamp of at least one of the connector apparatuses includes a post extending from the flange or the platform, wherein the other one of the flange or the platform engages the post at a pivot such that the flange or the platform is pivotable relative to the pivot to move the second one of the support feet toward the first one of the support feet when moving the clamp to the locked position.

Clause 10: The support assembly as set forth in any one of the preceding clauses wherein the post extends from the flange, and wherein the platform includes a first end having the second one of the support feet pivotably coupled thereto and a second end having the pivot.

Clause 11: The support assembly as set forth in any one of the preceding clauses wherein the sub-assembly includes a fastener component disposed through the platform and fed into the pin to clamp the sub-assembly to the pin such that the first one and the second one of the support feet sandwich the frame structure therebetween in the locked position.

Clause 12: The support assembly as set forth in any one of the preceding clauses wherein the clamp of at least one of the connector apparatuses includes a post extending from the flange or the platform, wherein the pivot point of the first one of the support feet and the second one of the support feet are spaced radially away from the longitudinal axis, and wherein the pivot is spaced radially away from the longitudinal axis, and wherein the fastener component is rotatable about the longitudinal axis to thread into a distal end of the respective pin.

Clause 13: The support assembly as set forth in clause 1 or 2 wherein at least one of the connector apparatuses includes a bearing block sandwiched between the first frame section and the support foot of the respective pin when the clamp is in the locked position.

Clause 14: The support assembly as set forth in any one of clauses 1, 2, and 13 wherein the clamp is further defined as a C-clamp, and wherein the pivot point is disposed at a distal end of the respective pin such that the support foot is pivotable relative to the longitudinal axis.

Clause 15: The support assembly as set forth in any one of clauses 1, 2, 13, and 14 wherein the C-clamp includes a first foot engaging a first part of the first frame section, and a second foot engaging the bearing block at a second part of the first frame section to sandwich part of the frame structure between the first foot and the second foot.

Clause 16: The support assembly as set forth in any one of clauses 1, 2, and 13-15 wherein the lock of at least one of the connector apparatuses is further defined as a collar surrounding the respective pin and the collar includes a lever to operate the lock to the disengaged position and the engaged position, and wherein at least one of the connector apparatuses includes a bracket attached to the respective one of the arms to couple the collar to the respective one of the arms.

Clause 17: The support assembly as set forth in any one of clauses 1-3 wherein at least one of the connector apparatuses includes a cylinder attached to the pin and the cylinder defines a cutout, and wherein the support foot is coupled to the respective pin via the cylinder.

Clause 18: The support assembly as set forth in any one of clauses 1-3 and 17 wherein the cylinder includes a first end and a second end opposing each other along the longitudinal axis, and the support foot is coupled to the first end of the cylinder along the longitudinal axis such that the support foot is pivotable relative to the longitudinal axis, and wherein the respective pin is coupled to the second end of the cylinder.

Clause 19: The support assembly as set forth in any one of clauses 1-3, 17, and 18 wherein the clamp is further defined as a C-clamp, and wherein the C-clamp includes a first foot engaging a first part of the first frame section, and a second foot disposed inside of the cutout to engage the cylinder which positions the support foot of the cylinder between the first foot and the second foot such that the support foot of the cylinder engages a second part of the first frame section to sandwich part of the frame structure between the first foot and the second foot when the clamp is in the locked position.

Clause 20: The support assembly as set forth in any one of clauses 1-3 and 17-19 wherein the respective pin, the first foot of the C-clamp, and the second foot of the C-clamp aligns with the support foot along the longitudinal axis when the clamp is in the locked position.

Clause 21: The support assembly as set forth in any one of the preceding clauses wherein the support frame includes a central beam and each of the arms extend outwardly from the central beam, and wherein one or more of the arms includes a telescoping beam portion to change a position of one or more of the connector apparatuses relative to the central beam.

Clause 22: A method of supporting a frame structure including a first frame section and a second frame section, the method comprising: positioning the frame structure relative to a support frame, wherein the support frame includes a plurality of arms extending outwardly to present a support grid, wherein a plurality of connector apparatuses are each arranged on the support grid; moving a pin of each of the connector apparatuses axially along a longitudinal axis to position the pin relative to the frame structure; activating a lock to engage the pin in an engaged position to fix the pin in a stationary position relative to the support frame or to release the pin in a disengaged position to allow movement of the pin relative to the support frame; operating a clamp of each of the connector apparatuses to move to a locked position in which the clamp attaches together the frame structure and the support frame or to move to an unlocked position in which the clamp releases the frame structure from the support frame; and wherein operating the clamp to the locked position fixes the first frame section on the support grid of the arms in an arrangement that provides repeatable nominal attachment and detachment of the second frame section relative to the first frame section.

Clause 23: The method as set forth in clause 22 further comprising removing the second frame section from the first frame section while the first frame section remains fixed to the support grid.

Clause 24: The method as set forth in clause 22 or 23 further comprising performing a task to the second frame section, and wherein performing the task occurs after removing the second frame section from the first frame section and while the first frame section remains fixed to the support grid.

Clause 25: The method as set forth in one of clauses 22-24 further comprising reattaching second frame section to the first frame section while the first frame section remains fixed to the support grid, and wherein reattaching the second frame section occurs after performing the task to the second frame section.

Clause 26: The method as set forth in one of clauses 22-25 wherein the frame structure is a determinate assembly in which the first frame section and the second frame sections each define a plurality of holes of determinate size, and wherein reattaching the second frame section to the first frame section further comprises aligning the holes of the second frame section to the holes of the first frame section and pinning the second frame section to the first frame section once the corresponding holes are aligned.

Clause 27: The method as set forth in one of clauses 22-26 further comprising repositioning at least one of the arms to change the arrangement of the support grid to accommodate a different configuration of the frame structure.

Clause 28: The method as set forth in one of clauses 22-27 wherein repositioning the at least one of the arms further comprises telescoping a telescoping beam portion to move at least one of the arms to change a position of the respective connector apparatuses.

What is claimed is:

1. A support assembly for a frame structure having a first frame section and a second frame section, the support assembly comprising:
a support frame including a plurality of arms extending outwardly to present a support grid;
a plurality of connector apparatuses each arranged on the support grid, wherein each of the connector apparatuses include a pin movable axially along a longitudinal axis and a lock coupled to the pin, wherein the lock is configured to release the pin in a disengaged position to allow movement of the pin relative to the support frame and the lock is configured to engage the pin in an engaged position to fix the pin in a stationary position relative to the support frame; and
wherein each of the connector apparatuses include a clamp configured to move from a locked position in which the clamp attaches together the frame structure and the support frame and an unlocked position in which the clamp releases the frame structure from the support frame, wherein the clamp of each of the connector apparatuses cooperates with the respective pin to attach the first frame section to the support frame when the respective clamp is in the locked position which fixes the first frame section on the support grid of the arms in an arrangement that provides repeatable nominal attachment and detachment of the second frame section relative to the first frame section.

2. The support assembly as set forth in claim 1 wherein each of the connector apparatuses include at least one support foot coupled to the respective pin at a pivot point, wherein the support foot is pivotable relative to the respective pin via the pivot point.

3. The support assembly as set forth in claim 2 wherein the lock of at least one of the connector apparatuses is further defined as a collet, and the collet is attached to the respective one of the arms in the arrangement of the support grid.

4. The support assembly as set forth in claim 1 wherein the clamp of at least one of the connector apparatuses include a sub-assembly separable from the respective pin to position the frame structure relative to the support frame, and the sub-assembly is couplable to the respective pin to attach the frame structure to the support frame.

5. The support assembly as set forth in claim 4 wherein each of the connector apparatuses include at least one support foot coupled to the respective pin at a pivot point, wherein the support foot is pivotable relative to the respective pin via the pivot point.

6. The support assembly as set forth in claim 5 wherein the at least one support foot is further defined as a plurality of support feet, wherein a first one of the support feet is coupled to the respective pin and engages a first part of the first frame section, and a second one of the support feet is coupled to the respective sub-assembly and engages a second part of the first frame section to sandwich part of the frame structure between a pair of the first and second ones of the support feet.

7. The support assembly as set forth in claim 6 wherein:
the clamp of at least one of the connector apparatuses includes a flange fixed to and extending outwardly from the respective pin, wherein the flange has the pivot point, and wherein the first one of the support feet is pivotably coupled to the flange at the pivot point; and
the sub-assembly of the clamp includes a platform and the second one of the support feet is coupled to the platform at a pivot point, wherein the second one of the support feet is pivotable relative to the platform via the pivot point.

8. The support assembly as set forth in claim 7 wherein the clamp of at least one of the connector apparatuses includes a post extending from the flange or the platform, wherein the other one of the flange or the platform engages the post at a pivot such that the flange or the platform is pivotable relative to the pivot to move the second one of the support feet toward the first one of the support feet when moving the clamp to the locked position.

9. The support assembly as set forth in claim 8 wherein the post extends from the flange, and wherein the platform includes a first end having the second one of the support feet pivotably coupled thereto and a second end having the pivot.

10. The support assembly as set forth in claim 7 wherein:
the sub-assembly includes a fastener component disposed through the platform and fed into the pin to clamp the sub-assembly to the pin such that the first one and the second one of the support feet sandwich the frame structure therebetween in the locked position; and
the clamp of at least one of the connector apparatuses includes a post extending from the flange or the platform, wherein the pivot point of the first one of the support feet and the second one of the support feet are spaced radially away from the longitudinal axis, and wherein the pivot is spaced radially away from the longitudinal axis, and wherein the fastener component is rotatable about the longitudinal axis to thread into a distal end of the respective pin.

11. The support assembly as set forth in claim 2 wherein at least one of the connector apparatuses includes a bearing block sandwiched between the first frame section and the support foot of the respective pin when the clamp is in the locked position.

12. The support assembly as set forth in claim 11 wherein the clamp is further defined as a C-clamp, and wherein the pivot point is disposed at a distal end of the respective pin such that the support foot is pivotable relative to the longitudinal axis.

13. The support assembly as set forth in claim 12 wherein the C-clamp includes a first foot engaging a first part of the first frame section, and a second foot engaging the bearing block at a second part of the first frame section to sandwich part of the frame structure between the first foot and the second foot.

14. The support assembly as set forth in claim 12 wherein the lock of at least one of the connector apparatuses is further defined as a collar surrounding the respective pin and the collar includes a lever to operate the lock to the disengaged position and the engaged position, and wherein at least one of the connector apparatuses includes a bracket attached to the respective one of the arms to couple the collar to the respective one of the arms.

15. The support assembly as set forth in claim 2 wherein at least one of the connector apparatuses includes a cylinder attached to the pin and the cylinder defines a cutout, and wherein the support foot is coupled to the respective pin via the cylinder.

16. The support assembly as set forth in claim 15 wherein the cylinder includes a first end and a second end opposing each other along the longitudinal axis, and the support foot is coupled to the first end of the cylinder along the longitudinal axis such that the support foot is pivotable relative to the longitudinal axis, and wherein the respective pin is coupled to the second end of the cylinder.

17. The support assembly as set forth in claim 16 wherein the clamp is further defined as a C-clamp, and wherein the C-clamp includes a first foot engaging a first part of the first frame section, and a second foot disposed inside of the cutout to engage the cylinder which positions the support foot of the cylinder between the first foot and the second foot such that the support foot of the cylinder engages a second part of the first frame section to sandwich part of the frame structure between the first foot and the second foot when the clamp is in the locked position.

18. The support assembly as set forth in claim 17 wherein the respective pin, the first foot of the C-clamp, and the second foot of the C-clamp aligns with the support foot along the longitudinal axis when the clamp is in the locked position.

19. The support assembly as set forth in claim 1 wherein the support frame includes a central beam and each of the arms extend outwardly from the central beam, and wherein one or more of the arms includes a telescoping beam portion to change a position of one or more of the connector apparatuses relative to the central beam.

20. A method of supporting a frame structure including a first frame section and a second frame section, the method comprising:
positioning the frame structure relative to a support frame, wherein the support frame includes a plurality of arms extending outwardly to present a support grid, wherein a plurality of connector apparatuses are each arranged on the support grid;
moving a pin of each of the connector apparatuses axially along a longitudinal axis to position the pin relative to the frame structure;
activating a lock to engage the pin in an engaged position to fix the pin in a stationary position relative to the support frame or to release the pin in a disengaged position to allow movement of the pin relative to the support frame;
operating a clamp of each of the connector apparatuses to move to a locked position in which the clamp attaches together the frame structure and the support frame or to move to an unlocked position in which the clamp releases the frame structure from the support frame; and
wherein operating the clamp to the locked position fixes the first frame section on the support grid of the arms in an arrangement that provides repeatable nominal attachment and detachment of the second frame section relative to the first frame section.
